(19) United States
(12) Patent Application Publication
(10) Pub. No.: US 2015/0317703 A1
(43) Pub. Date: Nov. 5, 2015

(54) SYSTEM AND METHOD FOR INDIVIDUALIZED PRICING FOR HEALTHCARE

(71) Applicant: ZocDoc, Inc., New York, NY (US)

(72) Inventor: Oliver D. KHARRAZ TAVAKOL, Brooklyn, NY (US)

(73) Assignee: ZocDoc, Inc., New York, NY (US)

(21) Appl. No.: 14/268,235

(22) Filed: May 2, 2014

(51) Int. Cl. G06Q 30/02; G06Q 50/22

(52) U.S. Cl. CPC G06Q 30/0283; G06Q 50/22

(57) ABSTRACT

Disclosed herein are systems, methods, and computer-readable storage devices for providing personalized pricing of medical services. A system can receive, from a healthcare provider, a range of prices for a medical service. The system can collect information associated with providing the medical service for a patient, and calculate a patient fairness factor score for the patient for the medical service based on the information. The patient fairness factor score can reflect an estimate of how complex providing that particular medical service for that particular patient is likely to be. The patient fairness factor score can closely affect the healthcare provider's cost to provide the medical service. Then the system can provide a price quote, within the range of prices and based on the patient fairness factor score, for the healthcare provider to provide the medical service for the patient.

### BACKGROUND

1. Technical Field

The present disclosure relates to healthcare pricing and more specifically to providing individualized pricing for medical services on a per-patient and per-provider basis.

2. Introduction

Often doctors do not know exactly how much to charge for medical services. Behavioral characteristics, age, gender, and other attributes of a given patient can largely influence the amount of work and associated cost required for a doctor to accommodate a particular patient's needs. For example, if one patient is extremely diligent in following the doctor's treatment instructions, then the treatment costs incurred by both the patient and doctor may be much lower. Conversely, if a different patient fails to follow treatment instructions, the costs associated with treatment may be substantially higher.

Responsible patients also potentially pay more than necessary for work performed by doctors. For example, patients that have a record of consistently following treatment directions may be paying too much for the care they are receiving. Such responsible patients may not require more expensive follow-up treatment options that are at least partially included in the overall price for treatment.

Currently, doctors often have to set prices based on average work costs without having access to specific patient behavioral data or other data that may influence cost or a desired profitability benchmark or patient mix. As a result, patients who behave responsibly or otherwise have lower cost factors pay more than their fair share, while patients who are irresponsible or have higher cost factors pay less than their fair share, and doctors are potentially exposed to higher levels of risk if they accept a disproportionately large number of patients associated with higher costs. Existing approaches to resolve these problems are coarse and do not adequately account for variability in costs when determining a treatment price, especially when those treatment costs mostly depend on patient characteristics and behavior.

### BRIEF DESCRIPTION OF THE DRAWINGS

FIG. 1 illustrates an example system architecture;

FIG. 2 illustrates an example price range chart with adjustments for various factors;

FIG. 3A illustrates a first portion of an example user interface;

FIG. 3B illustrates a second portion of an example user interface;

FIG. 4 illustrates an example method embodiment; and

FIG. 5 illustrates an example system embodiment.

### DETAILED DESCRIPTION

Disclosed herein are systems, methods, and computer-readable storage devices for setting a treatment price for consumers seeking medical attention based on factors such as prior patient behavior, age, gender, personal medical history, family medical history, doctor-specified factors, and so forth. An example system can consider a variety of factors on an individual patient basis and/or on a per-doctor basis in order to calculate a price to provide a given medical service for an individual patient. The medical service can include providing diagnosis or consultation services, treating a given disease or ailment, or performing a specific procedure. The medical service can include a single instance of treatment or a complete or partial regime of treatment including preliminary or preparatory services (such as patient evaluations, blood tests, x-rays, and so forth), the actual treatment (such as a surgery or applying a cast), and follow-up services (such as a 6 week post-op checkup). Based on these factors, the system can assist doctors to calculate and assign a price to the work associated with treatment of a given disease or performing a specific procedure for a given patient. The system can calculate a price for providing a medical service for a particular patient. The price can be based on personalized factors associated with the treatment. The doctor, via an automated system, preferences, or an algorithm, can set the price based on the patient's profile, based on other data collected about an individual patient, and/or based on other factors influencing price of the medical service. This approach can generate a personalized price point for medical services, which reflects an expected cost to the doctor in terms of time, resources, and/or money to provide the requested medical service. The variables for the personalized price point can be based on available personal and medical information about the prospective patient, information about the doctor, about doctor preferences, and so forth.

The system can gather patient and treatment data from a variety of sources, such as a large dataset on patient behavior. The system can gather data from sources not traditionally used to measure treatment compliance, including patient appointment scheduling data, personal patient treatment history, doctor expertise, local market pricing, and so forth.

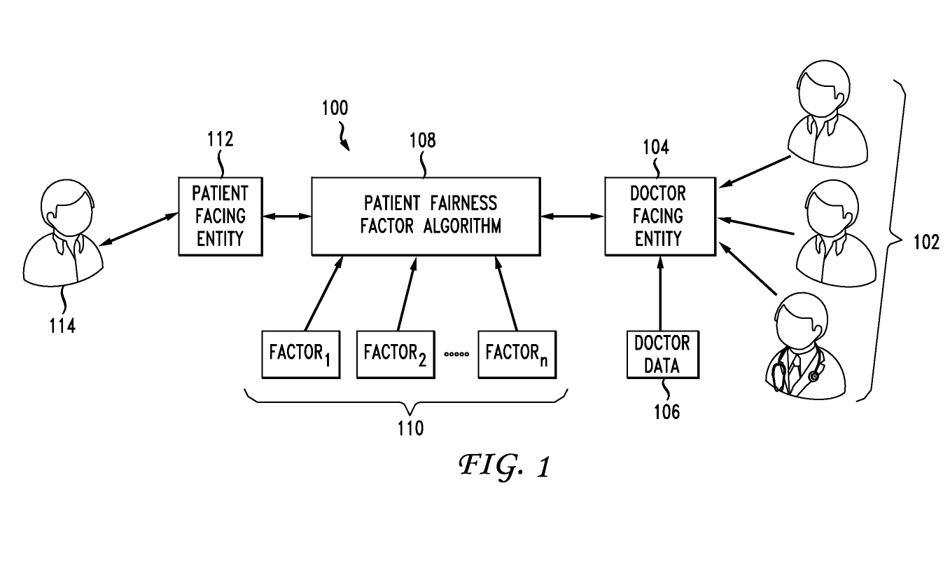

FIG. 1 illustrates an example system architecture 100 for calculating a price for providing a medical service for a patient. In this architecture 100, doctors 102 provide to a doctor facing entity 104 price ranges for various medical services. Doctors 102 can also provide a set of parameters, preferences, or settings to the doctor facing entity 104 governing how the price ranges are adjusted for particular patients, how the doctor appears in a listing, directory, or search results for patients, and any other aspect of the patient fairness factor algorithm 108. Doctors 102 can also provide quality and value indicators, e.g., a list of associated hospitals or medical care facilities where the doctor practices, a listing of insurance providers which the doctor accepts, videos, interviews, published articles, and any other media which the doctors 102 feel may be beneficial for patients. The doctors 102 and/or the patient facing entity 112 can determine how this additional data is presented to patients. For example, a doctor 102 or the patient facing entity can present a link to a doctor's published research article on ovarian cancer to any prospective patient searching for a doctor to treat cancer or reproductive issues, to allow the patient to easily find additional information which the patient can use in making an informed decision about selecting a doctor based on more points of data than price alone. The doctor facing entity 104 can include a hospital, an insurance group, a healthcare provider group, a government healthcare organization, an entity that schedules appointments with patients, a patient advocacy group, and so forth. The price ranges can be general or specific. In one embodiment, the price range can be associated with a “broken bone in a limb,” which is a general category for a price range. In another, more specific embodiment, the price range can be associated with a “laparoscopic gastric bypass.” The doctors 102 provide these ranges to the doctor facing entity 104 in currency amounts reflective of what the doctors 102 expect to charge to provide a given medical service for a patient. Doctors 102 can provide ranges of prices, such as $500-$850. The doctor facing entity 104 can also gather doctor data 106, such as experience, expertise, credentials, success rate with a particular procedure, treatment history, and so forth.

The doctor facing entity 104 can optionally show doctors 102 price ranges submitted by providers in the same market or in an equivalent market. In this way, doctors 102 can decide whether and how much to adjust their price ranges to be competitive. In one variation, the doctor facing entity 104 receives doctor data 106 from doctors 102 directly or from some third party or other source. Then the doctor facing entity 104 suggests a recommended price range to the doctors 102 based on market influences. The doctors can then modify a recommended price range rather than providing an initial price range.

The doctor facing entity 104 provides the price ranges and, optionally, the doctor data 106 to a patient fairness factor algorithm 108. The patient fairness factor algorithm 108 can retrieve multiple different factors 110 affecting the patient fairness factor and associated prices for a particular procedure. The patient fairness factor algorithm 108 can consider revenue cycle information, no-show behavior of patients, and other factors that directly or indirectly influence price for the doctor to provide treatment. The patient fairness factor algorithm 108 can be implemented via software, hardware, or a combination thereof. The doctor facing entity 104 can include a management interface for doctors 102 to manage, update, change, add, or remove information or the doctor data 106. The management interface can also provide analytics or performance data for a particular doctor or group of doctors. The management interface can also allow a given doctor to view other providers' data in an aggregate, anonymous form as a market benchmark. The management interface can also provide suggestions or recommendations, based on analytics data from other doctors, for how to modify a price range or various doctor-specified parameters for the patient fairness factor algorithm 108. The patient fairness factor algorithm 108 can access the various sources of the different factors 110 via an application programming interface (API) for each of the various sources. The sources of the different factors 110 can include patient clinical history, a patient ‘responsibility’ score (indicating how well the patient follows caregiver instructions), risk transfer payment information from an insurance provider, and so forth. The patient fairness factor algorithm 108 can use this information to generate a personalized price not just based on information about the patient, but potentially tailored for the market and specific combination of patient, doctor, and type of medical service to be provided. The patient fairness factor algorithm 108 can gather information from external sources, from a patient history, from the patient directly (such as via a patient facing entity 112), from the doctor facing entity 104, and so forth. The doctor facing entity 104, the patient fairness factor algorithm 108, and the patient facing entity 112 can each operate as part of a single organization or as separate entities. For example, a first company can implement the doctor facing entity 104 and the patient fairness factor algorithm 108, while a second company can implement the patient facing entity 112.

The patient fairness factor algorithm 108 can be part of a website, can be accessible via an API, integrated as part of the doctor facing entity 104 infrastructure, and so forth. Various portions of the patient fairness factor algorithm 108 can be distributed in different places. The patient fairness factor algorithm 108 can respond to patient requests for a particular procedure. For example, a patient 114, through a patient facing entity 112 like a website, mobile app, or a hospital kiosk, requests an appointment through a doctor scheduling portal for an initial consultation with a doctor about a hip replacement. The patient fairness factor algorithm 108 can, upon receiving the request, pull the various factors 110, including patient-specific data, request the price ranges from the doctor facing entity 104 (or from multiple healthcare entities), perform the calculations, and provide ranges of prices to the patient for each available doctor 102 that are within the price ranges that the doctors indicated.

The patient fairness factor algorithm 108 can execute an algorithm that analyzes the available data and assigns a price for a particular medical service. The specific algorithm can be fixed on a per-service basis, or the algorithm can be tailored for specific doctors, for example. The patient fairness factor algorithm 108 may apply a different algorithm for different doctors providing the same medical service, such as based on a particular doctor's treatment record for a given medical service, specific overhead costs associated with providing the given medical service, and so forth. The patient fairness factor algorithm 108 can assign weights to the available factors, and can discard or ignore some factors or make others a mandatory prerequisite for performing a particular price calculation.

The patient fairness factor algorithm 108 can gather doctor data 106 from the doctor facing entity 104 in advance of and/or independent of a patient inquiry for medical services. For example, doctors 102 can provide doctor data 106 and price ranges to the patient fairness factor algorithm 108 via the doctor facing entity 104 as part of an enrollment process or on a periodic price adjustment basis. However, the patient fairness factor algorithm 108 may request doctor data 106 upon receiving a request from a patient or prospective patient. In another variation, the patient fairness factor algorithm 108 collects doctor data 106 independently of patient requests, as that data is more likely to be static, and collects patient data and other factors 110 upon receiving a request from a patient 114.

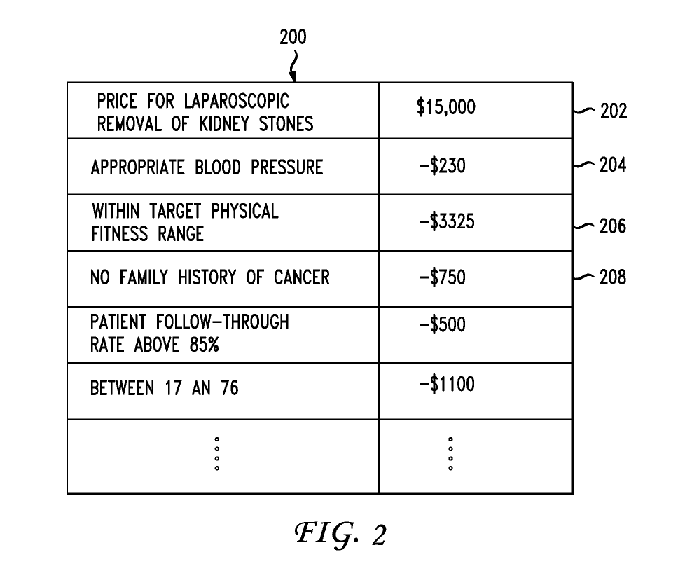

Once the patient fairness factor algorithm 108 has the doctor data 106, price ranges, and the other available factors 110 which may be indicative of treatment complexity or cost for example, the patient fairness factor algorithm 108 can compile a chart of prices and modifiers, such as the chart 200 shown in FIG. 2 with a price 202 for performing a medical service, in this case laparoscopic removal of kidney stones. The various price adjustments 204, 206, 208 show how different patient fairness factors can affect the patient's personalized price. In a main example, price adjustments 204, 206, 208 are discounts, or downward price deviations for positive behavior, reduced risk factors, or a desired patient mix for the doctor. In another example, if empirical or clinical data show that a patient with a certain condition has higher treatment costs, the patient fairness factor algorithm 108 can adjust the price upward by the indicated amount. Similarly, a patient within a target physical fitness range or without a family history of cancer 208 may have a decreased treatment price. The physical fitness range can be based on one or more factors, such as a resting heart rate, BMI, age, results of a physical fitness evaluation, and so forth. Some factors may reduce the treatment price, such as having a follow-through rate above 85%, which the table 200 shows reduces the price by $500. However, the system can constrain prices to remain within a price range. Other price factors can include patient behavior such as payment history and history of cancellation notifications for a particular patient. Although the prices 202, 204, 206, 208 are shown in FIG. 2 as a single price, one or more of the prices can be presented as a range of prices.

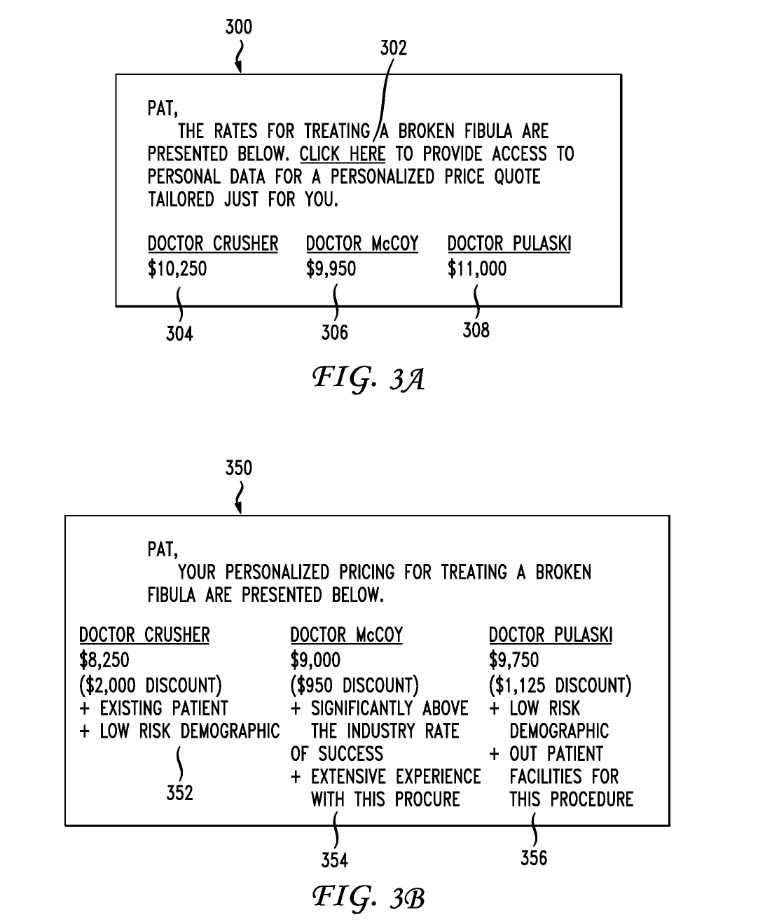

After the patient fairness factor algorithm 108 generates a personalized price, the patient facing entity 112 can present that price to the patient 114. The patient fairness factor algorithm 108 can perform this process for multiple doctors and present several personalized prices for different doctors. FIGS. 3A and 3B show example user interfaces 300, 350 demonstrating presenting different prices for multiple doctors. These user interfaces 300, 350 are illustrated in terms of a web site, but similar user interfaces can be provided via different media, such as via a mobile or tablet app, a kiosk, an interactive voice response system, a special-purpose application, email, text message, social media, and so forth.

FIG. 3A shows an example user interface 300 in which a user has made an inquiry about treating a broken fibula. The user interface 300 provides prices 304, 306, 308 for three different doctors. While the user interface shows individual doctors, the same principles can be applied to groups of doctors, or to hospitals. For example, the price may reflect any qualified doctor at a particular hospital without committing to a specific doctor at this early phase. At this stage, the patient fairness factor algorithm 108 only has data about the doctors, and not about the patient. Thus, the patient fairness factor algorithm 108 can provide prices that do not reflect patient-specific data. In the absence of such data, the patient fairness factor algorithm 108 can provide prices reflective of the maximum of the range, a doctor's desired or preferred price point, an average price that doctor charges for that particular service, or some other price. The patient can click the embedded link 302 or perform some other action to provide additional patient data directly or to authorize the patient fairness factor algorithm 108 to access personal patient data such as one of the factors 110 shown in FIG. 1. The dialog and user interfaces through which the patient provides the additional patient data or access to the additional patient data are not shown herein. In one example, the patient enters additional data about him or herself. In another example, the patient authorizes the system to look up his or her medical records. In yet another example, the patient provides credentials which the system can use to authenticate with a secure database to obtain the additional patient data.

FIG. 3B shows an example user interface 350 after the patient has provided or authorized access to the additional patient data. The user interface 350 can show the original or “list” price for each doctor, as well as the reduced price. This can help patients understand and appreciate which doctors are offering better deals. Inasmuch as patients often make decisions regarding medical services based on more than just price, the user interface 350 can also provide, at this point or at some other point in the process, additional data 352, 354, 356 about each doctor, data describing why a particular price has been adjusted, an amount or percentage by which the price has been adjusted, likelihood of success of the requested medical procedure, likelihood of complications associated with the requested medical procedure, reviews of that doctor or of that procedure with that doctor written by other patients, medical facilities and amenities available, and so forth. In this way, the patient is empowered to make a more informed decision as a customer or consumer of the medical services. When the patient decides which doctor to go with, the patient can click on the name for that doctor to set up an appointment, for example. The system can present to the patient various agreements, disclaimers, or other documents or paperwork to fill out in connection with receiving treatment with that doctor.

In one variation, the example user interface 350 shows the discounts, while hiding the underlying reasons for the discounts. In one variation, the user interface 350 can show the non-discounted price, the discounted price, and other information about the doctor to provide value transparency, not just price transparency.

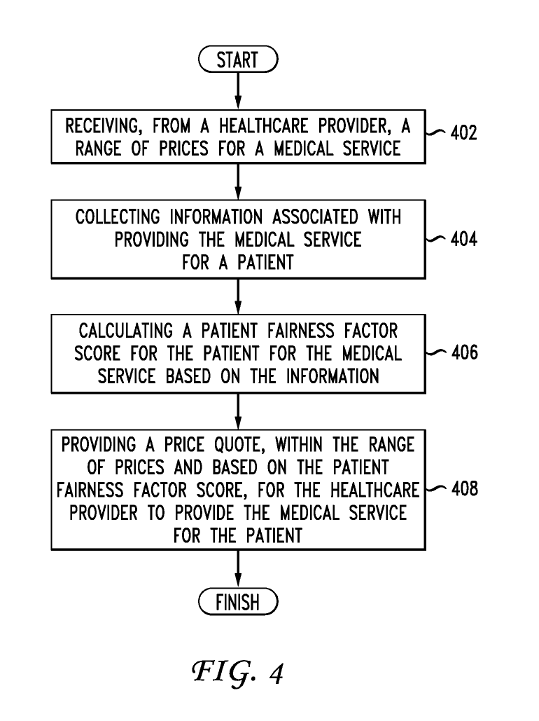

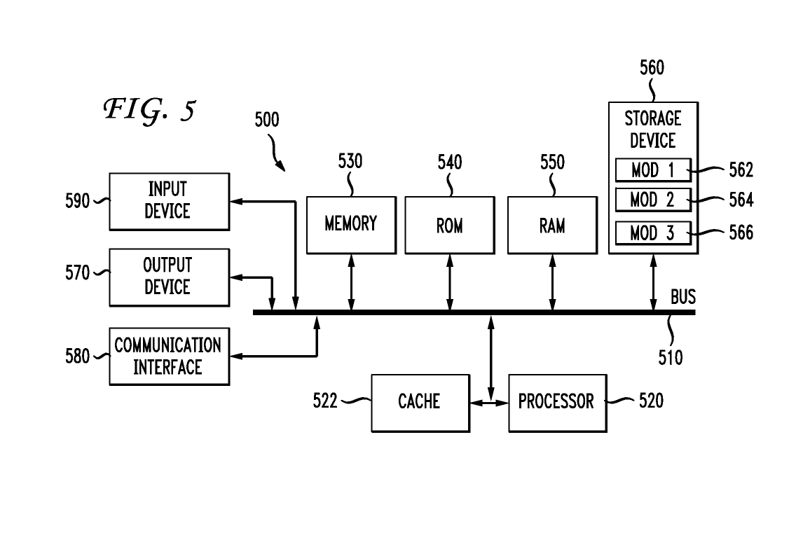

After the patient has selected a specific doctor for the medical services, the system can continue to track actual costs for the doctor associated with providing the medical services. For example, the system can tie in with doctor's billing and time tracking systems, or the doctor can manually input the data. The system can then provide analytics data to the doctor about profitability, risk, amount of time spent with the patient, and so forth. The system can also provide context for the analytics data, such as similar statistics for other doctors operating in the same or similar marketplaces. The doctor can then better decide how to position these services in the marketplace. For example, the doctor can lower the price range as a loss-leader to bring in new patients, or can increase the price range or how the various factors modify the price if the doctor discovers that treatment of a particular procedure is taking longer, on average, than expected. Doctors can then sort this analytics data by type of medical service, type of patient fairness factor score, or any other available attribute. Alternatively, the system can analyze actual cost and patient treatment data to automatically adjust the algorithm or factor weights that the patient fairness factor algorithm 108 uses to calculate prices for medical services. As part of the feedback regarding price, the system can further consider insurance company reimbursements and associated cost caps. This can allow doctors to have a desired payment mix and patient mix. For example, the doctor can choose to offer a sliding scale of discounts from more aggressive to less aggressive, based on how well a given patient matches a doctor's preferred payment mix and patient mix. In certain circumstances, based on a doctor's indicated preferences for a patient mix or payment mix, the system can remove a doctor from a listing of available doctors presented to a particular patient. For example, if a doctor already has above a desired threshold of patients of a particular category, the doctor's preferences or settings may indicate to the system to exclude the doctor from listing of available doctors presented to patients matching that category. This approach enables the system to connect the right patients with the right doctors at the right price point. Having disclosed some system components, concepts, and interfaces, the disclosure now turns to the exemplary method embodiment shown in FIG. 4. For the sake of clarity, the method is described in terms of an exemplary system as shown in FIG. 5 configured to practice the method. The steps outlined herein are exemplary and can be implemented in any combination thereof, including combinations that exclude, add, or modify certain steps. The example system can receive, from a healthcare provider, a range of prices for a medical service (402). The system can collect information associated with providing the medical service for a patient (404). The system can collect the information from one or more sources, such as a patient profile or a remote source via an API. The information can include, for example, a clinical history of the patient, co-morbidities of the patient, a patient treatment compliance history, a risk transfer payment table, outcome with similar patients, cost of treating similar patients, demographic information of the patient, behavioral information of the patient, expertise of the healthcare provider with the medical service, profitability of similar previous medical services, or regional pricing for the medical service. The system can alternatively gather this data directly from the patient, such as via an HTML form or data entered via a mobile app. The system can also provide the user with an interface for creating a “what-if” scenario by modifying the information. For example, the user can make temporary changes to the data provided processed by the algorithm, and view changes in the price quote based on the “what-if” scenario posed by those temporary changes.

The system can calculate a patient fairness factor score for the patient for the medical service based on the information (406) according to an algorithm. The system can assign weights to one or more of the factors when calculating the patient fairness factor score.

The system can provide a price quote, within the range of prices and based on the patient fairness factor score, for the healthcare provider to provide the medical service for the patient (408). The system can present the price quote to a patient in response to a request for the medical service. Then, upon receiving acceptance of the price quote from the patient, the system can either schedule the medical service for the patient with the healthcare provider, or can connect the patient to a separate service for scheduling the medical service. The system can optionally present to the patient the price quote for the healthcare provider along with other price quotes for other healthcare providers. Whether the system presents one or multiple healthcare providers may depend on the type or parameters of the initial inquiry for medical services. The system can optionally present to the patient at least one underlying factor affecting a respective price quote.

The system can, upon receiving the request for the medical service, determine that additional patient information is needed for the price quote. For example, some critical factor in the algorithm for that particular treatment may be absent or unavailable. In these situations, the system can either present the maximum price for that particular medical service, or the system can solicit the additional patient information from the patient prior to presenting the price quote. Upon receiving the additional patient information, the system can proceed to provide a refined, personalized price quote. In order to encourage patients to provide as much relevant information as possible, the system can present a non-discounted price quote to the patient, present an average savings off the non-discounted price quote, and present to the patient a first option to proceed using the non-discounted price quote, and a second option to provide the additional patient information to view a discounted price quote based on the additional patient information. This approach allows the patient to make the decision whether or not to share additional relevant information in order to reduce the price. When the patient opts to provide the additional personal medical data, the system can gather the additional information from the patient, and calculate the patient fairness factor score for the patient for the medical service based on the information and based on the additional patient information in order to present a personalized price quote.

The system can receive, from the healthcare provider, patient filtering criteria. For example, a particular doctor's operations may not be optimized for a particular type of complication or particular variation of treatment. In order to avoid those types of patients or services or, alternatively, to increase the price for providing such services, the system can adjust the price quote based on the doctor-specific patient filtering criteria. In another variation, healthcare providers establish price goals, such as increasing an hourly rate, increasing total payments collected, or increasing the volume of patients. Then, the system can dynamically adjust the algorithm for generating price quotes for patients accordingly, to assist the healthcare provider in achieving that price goal.

In one variation, the system can receive, from each of a group of healthcare providers, a respective range of prices for a medical service. The system can receive, from a patient, an inquiry for the medical service. Then the system can collect information associated with providing the medical service for the patient. The system can calculate a patient fairness factor score for the patient for the medical service based on the information, and generate, in response to the inquiry, a respective price quote for each of the group of healthcare providers to provide the medical service for the patient based on the patient fairness factor score, wherein each respective price quote is within the respective range of prices for one of the groups of healthcare providers. Then the system can present to the patient the respective price quotes and context information associated with each respective price quote. The context information can include value criteria explaining why a particular price quote is at a particular price point.

In one variation, the system can receive, from a healthcare provider, a minimum acceptable price for performing a medical service. The system can collect information associated with providing the medical service for a patient inquiring about the medical service, and calculate a treatment cost factor for the patient for the medical service based on the information. Then the system can generate a price quote. The system can generate the price quote by starting at a maximum price and applying discounts, or starting at a minimum acceptable price and increasing the price based on various factors. In a blended approach, the system starts at a price point somewhere in the middle, such as at a price average, and applies a mixture of discounts and increases. The resulting price is the price for the healthcare provider to provide the medical service for the patient, and, upon the patient accepting the price quote, arrange for the healthcare provider to perform the medical service for the patient.

Various embodiments of the disclosure are described in detail herein. While specific implementations are described, it should be understood that this is done for illustration purposes only. Other components and configurations may be used without parting from the spirit and scope of the disclosure. A description of a basic general purpose system or computing device in FIG. 5 which can be employed to practice the concepts, methods, and techniques disclosed is illustrated. With reference to FIG. 5, an exemplary system and/or computing device 500 includes a processing unit (CPU or processor) 520 and a system bus 510 that couples various system components including the system memory 530 such as read only memory (ROM) 540 and random access memory (RAM) 550 to the processor 520. The system 500 can include a cache 522 of high-speed memory connected directly with, in close proximity to, or integrated as part of the processor 520. The system 500 copies data from the memory 530 and/or the storage device 560 to the cache 522 for quick access by the processor 520. In this way, the cache provides a performance boost that avoids processor 520 delays while waiting for data. These and other modules can control or be configured to control the processor 520 to perform various operations or actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the processor. The processor 520 may be a self-contained computing system, containing multiple cores or processors, a bus, memory controller, cache, etc. A multi-core processor may be symmetric or asymmetric. The processor 520 can include multiple processors, such as a system having multiple, physically separate processors in different sockets, or a system having multiple processor cores on a single physical chip. Similarly, the processor 520 can include multiple distributed processors located in multiple separate computing devices, but working together such as via a communications network. Multiple processors or processor cores can share resources such as memory 530 or the cache 522, or can operate using independent resources. The processor 520 can include one or more of a state machine, an application specific integrated circuit (ASIC), or a programmable gate array (PGA) including a field PGA.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 may further include storage devices 560 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 560 can include software modules 562, 564, 566 for controlling the processor 520. The system 500 can include other hardware or software modules. The storage device 560 is connected to the system bus 510 by a drive interface. The drives and the associated computer-readable storage devices provide nonvolatile storage of computer-readable instructions, data structures, program modules and other data for the computing device 500. In one aspect, a hardware module that performs a particular function includes the software component stored in a tangible computer-readable storage device in connection with the necessary hardware components, such as the processor 520, bus 510, display 570, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 500 is a small, handheld computing device, a desktop computer, or a computer server. When the processor 520 executes instructions to perform “operations”, the processor 520 can perform the operations directly and/or facilitate, direct, or cooperate with another device or component to perform the operations.

Although the exemplary embodiment(s) described herein employs the hard disk 560, other types of computer-readable storage devices which can store data that are accessible by a computer, such as magnetic cassettes, flash memory cards, digital versatile disks (DVDs), cartridges, random access memories (RAMs) 550, read only memory (ROM) 540, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations described below, and random access memory (RAM) 550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5 can practice all or part of the recited methods, can be a part of the recited systems, and/or can operate according to instructions in the recited tangible computer-readable storage devices. Such logical operations can be implemented as modules configured to control the processor 520 to perform particular functions according to the programming of the module. For example, FIG. 5 illustrates three modules Mod1 562, Mod2 564 and Mod3 566 which are modules configured to control the processor 520. These modules may be stored on the storage device 560 and loaded into RAM 550 or memory 530 at runtime or may be stored in other computer-readable memory locations.

One or more parts of the example computing device 500, up to and including the entire computing device 500, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 520 can include all types of processors disclosed herein, including a virtual processor. However, when referring to a virtual processor, the processor 520 includes the software components associated with executing the virtual processor in a virtualization layer and underlying hardware necessary to execute the virtualization layer. The system 500 can include a physical or virtual processor 520 that receives instructions stored in a computer-readable storage device, which causes the processor 520 to perform certain operations. When referring to a virtual processor 520, the system also includes the underlying physical hardware executing the virtual processor 520.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied on an individual basis for a single doctor, for a group of doctors practicing together, or for an entire marketplace of doctors that can provide certain medical services. The same principles can be applied to a wide variety of other types of services. For example, similar approaches can be applied to multiple different types of services, such as dental services, mental health services, cleaning, catering, transactional legal work, vacations, tours, and so forth. In some variations, doctors can provide a base price that can be increased based on various patient, doctor, treatment, or other factors rather than or in conjunction with discounting prices for services rendered. Various modifications and changes may be made to the principles described herein without following the example embodiments and applications illustrated and described herein, and without departing from the spirit and scope of the disclosure. For example, the algorithm and factors considered by the algorithm may change based on the specific type of services being provided. Claim language reciting “at least one of” a set indicates that one member of the set or multiple members of the set satisfy the claim.

We claim:

1. A method comprising:
receiving, from a healthcare provider, a range of prices for a medical service;
collecting information associated with providing the medical service for a patient;
calculating, via a processor, a patient fairness factor score for the patient for the medical service based on the information; and
providing a price quote, within the range of prices and based on the patient fairness factor score, for the healthcare provider to provide the medical service for the patient.

2. The method of claim 1, wherein the information is one or more factors comprising a clinical history of the patient, co-morbidities of the patient, a patient treatment compliance history, a risk transfer payment table, outcome with similar patients, cost of treating similar patients, demographic information of the patient, behavioral information of the patient, expertise of the healthcare provider with the medical service, profitability of similar previous medical services, success rate at a particular price point, or regional pricing for the medical service.

3. The method of claim 2, further comprising:
weighting the one or more factors when calculating the patient fairness factor score.

4. The method of claim 1, further comprising:
receiving, from the patient, a request for the medical service; and
presenting the price quote to the patient in response to the request.

5. The method of claim 4, further comprising:
upon receiving acceptance of the price quote from the patient, scheduling the medical service for the patient with the healthcare provider.

6. The method of claim 4, further comprising:
presenting, to the patient, the price quote for the healthcare provider and other price quotes for other healthcare providers.

7. The method of claim 6, further comprising:
presenting, to the patient, at least one underlying factor affecting a respective price quote.

8. The method of claim 4, further comprising:
upon receiving the request for the medical service, determining that additional patient information is needed for the price quote.

9. The method of claim 8, further comprising:
soliciting the additional patient information from the patient prior to presenting the price quote.

10. The method of claim 8, further comprising:
presenting a non-discounted price quote to the patient;
presenting an average savings off the non-discounted price quote; and
presenting to the patient a first option to proceed using the non-discounted price quote, and a second option to provide the additional patient information to view a discounted price quote based on the additional patient information.

11. The method of claim 10, further comprising, when the patient selects the second option:
gathering the additional patient information from the patient; and
calculating the patient fairness factor score for the patient for the medical service based on the information and based on the additional patient information.

12. The method of claim 1, wherein the information is retrieved from at least one of a patient profile or a remote source via an application programming interface.

13. The method of claim 1, further comprising:
receiving, from the healthcare provider, patient filtering criteria; and
adjusting the price quote based on the patient filtering criteria.

14. The method of claim 1, further comprising:
receiving, from the healthcare provider, a price goal; and
adjusting the price quote based on the price goal.

15. The method of claim 14, wherein the price goal comprises at least one of increasing an hourly rate, increasing total payments collected, or increasing the volume of patients.

16. The method of claim 1, further comprising:
providing, to the user, an interface for creating a “what-if” scenario by modifying the information, and for viewing changes in the price quote based on the “what-if” scenario.

17. The method of claim 1, further comprising:
tracking statistics of patients selecting price quotes as analytics data; and
providing the analytics data to healthcare providers.

18. A system comprising:
a processor; and
a computer-readable storage device storing instructions which, when executed by the processor, cause the processor to perform operations comprising:
receiving, from each of a plurality of healthcare providers, a respective range of prices for a medical service;
receiving, from a patient, an inquiry for the medical service;
collecting information associated with providing the medical service for the patient;
calculating a patient fairness factor score for the patient for the medical service based on the information;
generating, in response to the inquiry, a respective price quote for each of the plurality of healthcare providers to provide the medical service for the patient based on the patient fairness factor score, wherein each respective price quote is within the respective range of prices for one of the plurality of healthcare providers; and
presenting to the patient the respective price quotes and context information associated with each respective price quote.

19. The system of claim 18, wherein the context information comprises value criteria for explaining why a particular price quote is at a particular price point.

20. A computer-readable storage device storing instructions which, when executed by a computing device, cause the computing device to perform operations comprising:
receiving, from a healthcare provider, a minimum acceptable price for performing a medical service;
collecting information associated with providing the medical service for a patient inquiring about the medical service;
calculating a patient fairness factor score for the patient for the medical service based on the information;
generating a price quote adjusted based on the patient fairness factor score, for the healthcare provider to provide the medical service for the patient; and
upon the patient accepting the price quote, arranging for the healthcare provider to perform the medical service for the patient.
